(19) United States
(12) Patent Application Publication
(10) Pub. No.: US 2014/0216553 A1
(43) Pub. Date: Aug. 7, 2014

(54) Dye-Sensitized Solar Cell via Co-Sensitization with Cooperative Dyes

(71) Applicants: Sean Vail, Vancouver, WA (US); David Evans, Bearverton, OR (US); Karen Nishimura, Washougal, WA (US); Wei Pan, Vancouver, WA (US); Jong-Jan Lee, Camas, WA (US)

(72) Inventors: Sean Vail, Vancouver, WA (US); David Evans, Bearverton, OR (US); Karen Nishimura, Washougal, WA (US); Wei Pan, Vancouver, WA (US); Jong-Jan Lee, Camas, WA (US)

(21) Appl. No.: 13/758,819

(22) Filed: Feb. 4, 2013

(51) Int. Cl. H01G 9/20; C09K 3/00

(52) U.S. Cl. CPC H01G 9/2063; C09K 3/00
USPC 136/263; 106/506; 136/252; 438/98

(57) ABSTRACT

A co-sensitized dye-sensitized solar cell (DSC) is provided, made from a transparent substrate and a transparent conductive oxide (TCO) film overlying the transparent substrate. An n-type semiconductor layer overlies the TCO, and is co-sensitized with a first dye (D1) and a second dye (D2). A redox electrolyte is in contact with the co-sensitized n-type semiconductor layer, and a counter electrode overlies the redox electrolyte. The first dye (D1) has a first optical absorbance local maxima at a first wavelength (A1) and a second optical absorbance local maxima at a second wavelength (A2), longer than the first wavelength. The second dye (D2) has a third optical absorbance local maxima at a third wavelength (A3) between the first wavelength (A1) and the second wavelength (A2). In one aspect, the first dye (D1) includes a porphyrin material, for example, a metalloporphyrin obtained by complexation with a transition metal such as zinc (i.e. zinc porphyrin (ZnP)).

### BACKGROUND OF THE INVENTION

1. Field of the Invention

This invention generally relates to dye-sensitive light absorbing chemistry and, more particularly, to dye-sensitized solar cells (DSCs) co-sensitized with two dyes.

2. Description of the Related Art

Although dye-sensitized solar cells (DSCs) have the potential to provide solar power as a clean, affordable, and sustainable technology, many challenges continue to persist. Overall, DSCs can provide power conversion efficiencies (PCEs) comparable to a variety of thin-film technologies with the advantage of reduced cost, both in terms of materials and processing. Despite the fact that high PCEs have been achieved in DSCs using mono-sensitization, many sensitizing dyes suffer from a deficiency in optical absorption beyond 700 nanometers (nm). Furthermore, the choice of sensitizer is typically limited to those exhibiting broad absorption yet weak absorbance, or strong absorbance over only a narrow wavelength region. In both cases, a considerable fraction of the incident sunlight fails to be effectively harnessed.

Certainly, one of the major limitations towards the realization of more efficient DSCs exists in an inability to construct a cell with an appropriate sensitizer that absorbs both strongly and broadly along wavelengths leading up to 1000 nm (or beyond) within a reasonably thin absorbing layer. Currently, there exists no individual sensitizer candidate capable of satisfying this requirement. Although tandem solar cells have been considered as viable alternatives to single junction DSC, the lack of efficient infrared (IR)-absorbing sensitizers prevents effective current matching.

Although numerous attempts have been made to expand absorption by way of co-sensitization using combinations of spectrally complementary sensitizers, the photovoltaic performances of DSCs have in many cases failed to exceed PCEs achieved using a single sensitizer, with the exception of some notable cases discussed below. In many cases, simultaneous or sequential co-adsorption of different sensitizers on the same TiO₂ substrate creates a scenario through which the deactivation of photo-excited states can proceed. Overall, dominance of these unfavorable “quenching” pathways is detrimental to sensitizer performance in DSC, thereby leading to overall PCEs that are lower than comparable devices fabricated using a single sensitizer. Other challenges include the requirement for two (or more) sensitizers to adsorb strongly on TiO₂, efficiently inject electrons into TiO₂, exhibit slow recombination kinetics, and regenerate with the redox couple.

Gaudiana et al. reported the beneficial impact of aromatic amines as co-sensitizers in DSC.¹ Chen et al. described an enhanced photovoltaic performance for co-sensitized DSCs containing a “molecular cocktail” of three organic dyes [Yellow Merocyanine Dye (Y), Red Hemicyanine Dye (R) and Blue Squarylium Cyanine Dye (B)].² Although Y, R and B individually absorb over relatively narrow wavelength ranges, the combined absorption spectra for the trio extends from <400 nm to −725 nm. Corresponding PCEs for the co-sensitized DSCs ranged from 4.7% to 6.5%, versus 2.8%, 4.6% and 3.9% for DSCs fabricated using mono-sensitization with Y, R, and B, respectively. Overall, the results are impressive in that they demonstrate the fact that a mixture of three different sensitizers can indeed behave cooperatively in DSC when co-adsorbed together on the same TiO₂ electrode.

Cid et al. provided a DSC fabricated from a TiO₂ substrate co-sensitized with zinc phthalocyanine (TT1) and a fluorene-based sensitizer (JK2).³ The co-sensitized DSC yielded PCE=7.74% (short circuit current (J_{sc})=16.2 mA/cm², open-circuit voltage (V_{oc})=666 mV, fill factor (FF)=0.72). For comparison, DSCs employing either TT1 or JK2 afforded PCEs of 3.52% and 7.1%, respectively. Yum et al. reported an enhanced DSC performance through co-sensitization using a combination of JK2 and a squarine-based dye (SQ1).⁴ Co-sensitized DSCs prepared using an optimized ratio of JK2 to SQ1 yielded an overall PCE=7.43% (J_{sc}=15.5 mA/cm², V_{oc}=685 mV, FF=0.70) versus 7.0% and 4.23%, respectively, for DSCs fabricated individually from either JK2 or SQ1. Kuang et al. demonstrated an enhanced performance for co-sensitized DSCs employing two organic dyes (SQ1 and JK2) with complementary spectral responses relative to devices fabricated from each of the individual dyes.⁵ A PCE=6.5% was achieved for the co-sensitized DSC using a binary ionic liquid (solvent-free) electrolyte. Cheng et al. described a co-sensitization strategy for DSC with organic dyes to achieve PCE=8.2% (J_{sc}=20.1 mA/cm², V_{oc}=597 mV and FF=68.3%) and demonstrated incident photon-to-current conversion efficiencies (IPCEs) exceeding 85% in the 400-700 nm range.⁶

Dualeh et al. reported a co-sensitization strategy for solid-state DSC (ssDSC) using a combination of squaraine-based dye (JD10) and organic dye (D35) with Spiro-OMeTAD as hole transport material (HTM) through which a PCE=4.42% was demonstrated, as compared to 3.16% for sensitization with JD10 alone.⁷ Brown et al. employed co-sensitization with a visible light-absorbing organic sensitizer (D102) and a near-IR (NIR)-absorbing zinc phthalocyanine complex to enhance the optical window in ssDSCs with Spiro-OMeTAD as HTM.⁸ The co-sensitized ssDSCs demonstrated PCE=4.7%, compared to 3.9% for the mono-sensitized device. Electronic and spectroscopic investigations proved that resonant energy transfer from the visible to NIR-sensitizer was operative and proceeded in conjunction with direct electron transfer from the photo-excited D102 sensitizer. Hardin et al. demonstrated successful photocurrent generation via intermolecular energy transfer from using an NIR-absorbing zinc naphthalocyanine (AS02) co-sensitized with a metal complex dye (C106) on the TiO₂ surface.^{9, 10}

Siegers et al. exploited energy transfer to improve light harvesting and current generation in DSC using a co-sensitized system consisting of a carboxy-functionalized 4-aminonaphthalimide dye (carboxy-fluorol) and N719 dye as donor and acceptor, respectively.¹¹ Fan et al. provided a co-sensitization approach using a ruthenium complex sensitizer (JK-142) in combination with a triarylamine-based sensitizer (JK-62), whereby a PCE of up to 10.2% was demonstrated and found to be superior to DSCs fabricated using N719 dye within the same device configuration.¹² Lee et al. reported a stepwise co-sensitization method for mesoporous TiO₂ that employed different sequences of adsorption in order to achieve a complementary spectral response.¹³ Furthermore, co-sensitization with N719/FL and Black dye/FL afforded optimized PCEs corresponding to 5.10% and 3.78%, which was determined to be higher than DSCs fabricated from either of the individual sensitizers. Sharma et al. provided a stepwise co-sensitization approach for DSC using a thiocyanate-free Ru(II) sensitizer (SPS-01) with an organic dye (TDPP).¹⁴ The optimized, co-sensitized DSC demonstrated J_{sc}=13.7 mA/cm², V_{oc}=700 mV, FF=0.72 and PCE=6.90%, which represented a significant improvement relative to devices fabricated individually from either SPS-01 (PCE=5.47%) or TDPP (PCE=4.82%) under the same conditions. Nguyen et al. described a co-sensitization strategy for ruthenium C106 dye and D131 dye as spectrally complementary sensitizers.¹⁵ DSCs fabricated from co-sensitized TiO₂ substrates demonstrated significant improvements in photovoltaic performance (PCE=11.1%) relative to those prepared individually from either C106 dye (9.5%) or D131 dye (5.6%). Holliman et al. demonstrated PCE=7.5% for DSC through effective co-sensitization using a triphenylamine dye in combination with N719 dye.¹⁶ Overall, the PCE for the co-sensitized DSC exceeded those observed for devices fabricated from individual sensitizers while the IPCE data confirmed efficient photon capture from multiple dyes in a single photo-electrode. Saxena et al. provided a co-sensitized DSC using ruthenium N3 dye and rhodamine 19 perchlorate dye through which IPCE was enhanced and dark current was reduced.¹⁷ Average PCEs of 4.7% were demonstrated for the co-sensitized DSCs as compared to 2.3% and 0.6% for devices fabricated individually from N3 and rhodamine 19 perchlorate dyes, respectively. Liu et al. reported the in situ chemical bath deposition (CBD) of PbS quantum dots (QDs) and photovoltaic performance of DSCs fabricated from TiO₂ electrodes co-sensitized with PbS QDs and N719 dye.⁸ Overall, DSCs co-sensitized with PbS QDs and N719 demonstrated PCE=6.35% compared to 5.95% for devices fabricated from N719 only.

Ogura et al. demonstrated PCE=11.0% for a co-sensitized DSC using a ruthenium complex (Black dye) in combination with an indoline dye (D131).^{19,20} Overall, the dark current was suppressed in the dual dye system (Black dye+D131). In addition, recombination phenomena involving electron capture from TiO₂ by the electrolyte was reduced due to the dense packing of adsorbed dyes. Recently, an indoline dye (D-1) was applied as a co-sensitizer for improving the spectral response of Black dye in DSC.²¹ The co-sensitized DSC (Black dye+D-1) demonstrated PCE=9.8% with higher J_{sc} (19.54 mA/cm²), as compared to devices prepared using only Black dye under standard AM 1.5 sunlight.

Yella et al. demonstrated enhanced DSC performance from co-sensitization with a combination of porphyrin dye (YD2-o-C8) and organic dye (Y123).²² Co-sensitized DSCs yielded an exceptional PCE=12.3% with Co(II/III) as redox mediator. Furthermore, the co-sensitized DSC exhibited an impressive photocurrent response over the entire visible region and demonstrated IPCEs >90% over a broad wavelength range below 700 nm. Griffith et al. reported a 300% efficiency enhancement in DSC using co-sensitization with two porphyrins for which IPCE data indicated an improved charge injection yield.²³ Wu et al. described the synthesis of a porphyrin dimer (YDD6) and subsequent application to co-sensitization in efforts to improve light harvesting beyond 700 nm.²⁴ Accordingly, a molecular cocktail consisting of a mixture of porphyrin (YD2-oC8), organic dye (CD4) and YDD6 in an optimized molar ratio was employed. The IPCE spectrum for DSC using the co-sensitization cocktail revealed high efficiencies (75-80%) in the 400-700 nm as well as considerable response (40-45%) in the NIR region (700-800 nm). Overall, the co-sensitized DSC demonstrated J_{sc}=19.28 mA/cm², V_{oc}=753 mV, FF=0.719 and PCE=10.4%, which was superior to the performance of DSCs consisting of individual or even dual dye systems. Shrestha et al. reported a co-sensitization using an organic dye (BET) with 2 different porphyrins (TMPZn or LD12).²⁵ For a DSC, an increase in PCE from 1.09% to 2.90% was demonstrated through co-sensitization with TMPZn and BET relative to TMPZn alone. With respect to co-sensitization using LD12 and BET, an increase in PCE from 6.65% to 7.60% was achieved relative to DSCs fabricated from LD12 only. Since direct electron injection from photo-excited BET to TiO₂ was determined to be inefficient, an intramolecular energy transfer model was proposed in order to account for the beneficial impact from co-sensitization. Finally, Lan et al. provided a co-sensitization method for DSC by employing a zinc porphyrin (LD12) in combination with an organic dye (CD5).²⁶ Overall, the co-sensitized DSC demonstrated improved J_{sc} and V_{oc} relative to the mono-sensitized devices. Furthermore, optimized DSCs fabricated from co-sensitized (LD12+CD5) TiO₂ substrates yielded J_{sc}=16.7 mA/cm², V_{oc}=740 mV, FF=0.73, and PCE=9.0%, as compared to 7.5% and 5.7% for devices fabricated individually from either LD12 or CD5, respectively.
1. R. Gaudiana, S. Hadjikyriacou, J-A. He, D. Walker and Z. Zhu, “Aromatic Amines as Co-sensitizers in Dye Sensitized Titania Solar Cells”, Journal of Macromolecular Science 2003, A40, 1295-1306.
2. Y. Chen, Z. Zeng, C. Li, W. Wang, X. Wang and B. Zhang, “Highly Efficient Co-sensitization of Nanocrystalline TiO₂ Electrodes with Plural Organic Dyes”, New Journal of Chemistry 2005, 29, 773-776.
3. J-J. Cid, J-H. Yum, S-R. Jang, M. K. Nazeeruddin, E. Martinez-Ferrero, E. Palomares, J. Ko, M. Grätzel and T. Torres, “Molecular Cosensitization for efficient Panchromatic Dye-Sensitized Solar Cells”, Angewante Chemie 2007, 119, 8510-8514.
4. J-H. Yum, S-R. Jang, P. Walter, T. Geiger, F. Nüesch, S. Kim, J. Ko, M. Grätzel and M. K. Nazeeruddin, “Efficient Co-sensitization of Nanocrystalline TiO₂ Films by Organic Photosensitizers”, Chemical Communications 2007, 4680-4682.
5. D. Kuang, P. Walter, F. Nüesch, S. Kim, J. Ko, P. Comte, S. M. Zakeeruddin, M. K. Nazeeruddin and M. Grätzel, “Co-sensitization of Organic Dyes for Efficient Ionic Liquid Electrolyte-Based Dye-Sensitized Solar Cells”, Langmuir 2007, 23, 10906-10909.
6. M. Cheng, X. Yang, J. Li, F. Zhang, L. Sun, “Co-sensitization of Organic Dyes for Efficient Dye-Sensitized Solar Cells”, ChemSusChem 2013, 6, 70-77.
7. A. Dualeh, J. H. Delcamp, M. K. Nazeeruddin and M. Grätzel, “Near-Infrared Sensitization of Solid-State Dye-Sensitized Solar Cells with a Squaraine Dye”, Applied Physics Letters 2012, 100, 173512.
8. M. D. Brown, P. Parkinson, T. Torres, H. Miura, L. M. Herz and H. J. Snaith, “Surface Energy Relay Between Cosensitized Molecules in Solid-State Dye-Sensitized Solar Cells”, Journal of Physical Chemistry C 2011, 115, 23204-23208.
9. B. E. Hardin, A. Sellinger, T. Moehl, R. Humphrey-Baker, J-E. Moser, P. Wang, S. M. Zakeeruddin, M. Grätzel and M. D. McGehee, “Energy and Hole Transfer between Dyes Attached to Titania in Cosensitized Dye-Sensitized Solar Cells”, Journal of the American Chemical Society 2011, 133, 10662-10667.
10. B. E. Hardin and M. D. McGehee, “Increased Near-Infrared Light Harvesting in Dye-Sensitized Solar Cells Using Co-sensitized Energy Relay Dyes on Titania”, US2012/0255614 A1.
11. C. Siegers, U. Wiirfel, M. Zistler, H. Gores, J. Holh-Ebinger, A.

Hinsch and R. Haag, “Overcoming Kinetic Limitations of Electron Injection in the Dye Solar Cell via Coadsorption and FRET”, ChemPhysChem 2008, 9, 793-798.
12. S-Q. Fan, C. Kim, B. Fang, K-X. Liao, G-J. Yang, C-J. Li, J-J. Kim and J. Ko, “Improved Efficiency of Over 10% in Dye-Sensitized Solar Cells with a Ruthenium Complex and an Organic Dye Heterogeneously Positioning on a Single TiO₂ Electrode”, Journal of Physical Chemistry C 2011, 115, 7747-7754.
13. K-M. Lee, Y-C. Hsu, M. Ikegami, T. Miyasaka, K. R. J. Thomas, J. T. Lin and K-C. Ho, “Co-sensitization Promoted Light Harvesting for Plastic Dye-Sensitized Solar Cells”, Journal of Power Sources 2011, 196, 2416-2421.
14. G. D. Sharma, M. S. Roy and S. P. Singh, “Improvement in the Power Conversion Efficiency of Thiocyanate-Free Ru(II) Based Dye Sensitized Solar Cells by Cosensitization with a Metal-Free Dye”, Journal of Materials Chemistry 2012, 22, 18788-18792.
15. L. H. Nguyen, H. K. Mulmudi, D. Sabba, S. A. Kulkarni, S. K. Batabyal, K. Nonomura, M. Grätzel and S. G. Mhaisalkar, “A Selective Co-sensitization Approach to Increase Photon Conversion Efficiency and Electron Lifetime in Dye-Sensitized Solar Cells” Physical Chemistry Chemical Physics 2012, 14, 16182-16186.
16. P. J. Holliman, M. Mohsen, A. Connell, M. L. Davies, K. Al-Salihi, M. B. Pitak, G. J. Tizzard, S. J. Coles, R. W. Harrington, W. Clegg, C. Serpa, O. H. Fontes, C. Charbonneau and M. J. Carnie, “Ultra-Fast Co-Sensitization and Tri-sensitization of Dye-Sensitized Solar Cells with N719, SQ1 and Triarylamine Dyes”, Journal of Materials Chemistry 2012, 22, 13318-13327.
17. V. Saxena, P. Veerender, A. K. Chauhan, P. Jha, D. K. Aswal and S. K. Gupta, “Efficiency Enhancement in Dye Sensitized Solar Cells Through Co-sensitization of TiO₂ Nanocrystalline Electrodes”, Applied Physics Letters 2012, 100, 133303.
18. Y. Liu and J. Wang, “Co-sensitization of TiO₂ by PbS Quantum Dots and Dye N719 in Dye-Sensitized Solar Cells”, Thin Solid Films 2010, e-54-e56.
19. R. Y. Ogura, S, Nakane, M. Morooka, M. Orihashi, Y. Suzuki, K. Noda, “High-Performance Dye-Sensitized Solar Cell with a Multiple Dye System”, Applied Physics Letters 2009, 94, 073308.
20. R. Yoneya, M. Orihashi, Y. Suzuki and M. Morooka, “Dye-sensitization Solar Cell and Method for Making the Same”, US2010/0269892 A1.
21. Md. Akhtaruzzaman, A. Islam, M. R. Karim, A. K. M. Hasan and L. Han, “Improving the Spectral Response of Black Dye by Cosensitization with a Simple Indoline Based Dye in Dye-Sensitized Solar Cell”, Journal of Chemistry, Volume 2013, Article ID 910527.
22. A. Yella, H-W. Lee, H. N. Tsao, C. Yi, A. K. Chandiran, Md. K. Nazeeruddin, E. W-G. Diau, C-Y. Yeh, S. M. Zakeeruddin, M. Grätzel, “Porphyrin-Sensitized Solar Cells with Cobalt (II/III)-Based Redox Electrolyte Exceed 12 Percent Efficiency”, Science 2011, 334, 629-633.
23. M. J. Griffith, A. J. Mozer, G. Tsekouras, Y. Dong, P. Wagner, K. Wagner, G. G. Wallace, S. Mori and D. L. Officer, “Remarkable synergistic effects in a mixed porphyrin dye-sensitized TiO₂ film”, Applied Physics Letters 2011, 98, 163502.
24. H-P. Wu, Z-W. Ou, T-Y. Pan, C-M. Lan, W-K. Huang, H-W. Lee, N. M. Reddy, C-T. Chen, W-S. Chao, C-Y. Yeh and E. W-G. Diau, “Molecular Engineering of Cocktail Co-sensitization for Efficient Panchromatic Porphyrin-Sensitized Solar Cells”, Energy & Environmental Science 2012, 5, 9843-9848.
25. M. Shrestha, L. Si, C-W. Chang, H. He, A. Sykes, C-Y. Lin and E. W-G. Diau, “Dual Functionality of BODIPY Chromophore in Porphyrin-Sensitized Nanocrystalline Solar Cells”, Journal of Physical Chemistry C 2012, 116, 10451-10460.
26. C-M. Lan, H-P. Wu, T-Y. Pan, C-W. Chang, W-S. Chao, C-T. Chen, C-L. Wang, C-Y. Lin and E. W-G. Diau, “Enhanced Photovoltaic Performance with Co-sensitization of Porphyrin and an Organic Dye in Dye-Sensitized Solar Cells”, Energy & Environmental Science 2012, 5, 6460-6464.

It would be advantageous if a combination of dyes could cooperate in the improvement of both the degree of optical absorbance and the range of wavelengths over which a DSC operates.

### SUMMARY OF THE INVENTION

Herein is described a means for enhancing the photovoltaic performance of dye-sensitized solar cells (DSCs) by employing a co-sensitization strategy using two different classes of sensitizer dyes, for example, porphyrins and ruthenium polypyridyl complexes. The effect of cooperative photo-electronics for the dual sensitizer system is evident at shorter and intermittent regions of the optical spectrum and is accompanied by an increase in photovoltaic response that extends to wavelengths beyond those of either of the individual sensitizers. Conveniently, the preparation of the co-sensitized TiO₂ substrates can proceed in a “one pot” approach, using, for example, the appropriate ratios of zinc porphyrin (ZnP) and Black dye (BD). Overall, the performance of DSC prototypes fabricated from TiO₂ substrates co-sensitized with ZnP and Black dye are superior to control DSCs prepared individually from either ZnP or Black dye in the identical DSC configuration. Furthermore, optical absorption studies confirm that TiO₂ substrates treated with a solution of ZnP and Black dye indicate the presence of both sensitizers, whereby the ratio can be controlled based upon relative molar amounts in the mixed dye solution and knowledge of adsorption rates for the individual dyes. The fundamental and practical evolution of this technology is discussed in detail in the Background Section, above.

Accordingly, a co-sensitized DSC is provided, made from a transparent substrate and a transparent conductive oxide (TCO) film overlying the transparent substrate. An n-type semiconductor layer overlies the TCO, and is co-sensitized with a first dye (D1) and a second dye (D2). A redox electrolyte is in contact with the co-sensitized n-type semiconductor layer, and a counter electrode overlies the redox electrolyte. The first dye (D1) has a first optical absorbance local maxima at a first wavelength (A1) and a second optical absorbance local maxima at a second wavelength (A2), longer than the first wavelength. The second dye (D2) has a third optical absorbance local maxima at a third wavelength (A3) between the first wavelength (A1) and the second wavelength (A2). In one aspect, the first dye (D1) includes a porphyrin material, for example, a metalloporphyrin obtained by complexation with a transition metal such as zinc (i.e. zinc porphyrin (ZnP)). In another aspect, the second dye (D2) includes a ruthenium complex, such as a ruthenium polypyridyl complex. Both the first dye (D1) and second dye (D2) are functionalized to the n-type semiconductor layer.

Additional details of the above-described DSC, a dye combination for co-sensitizing a DSC, and a method for fabricating a co-sensitized DSC are presented below.

### BRIEF DESCRIPTION OF THE DRAWINGS

FIG. 1 is a partial cross-sectional view of a co-sensitized dye-sensitized solar cell (DSC).

FIG. 2 is a graph of conceptual absorbance values vs. wavelength, associated with the DSC of FIG. 1.

FIG. 3 is a partial cross-sectional view depicting a variation of the DSC of FIG. 1.

FIG. 4 is a graph depicting the optical absorption spectra of ZnP and BD adsorbed separately onto transparent TiO₂ substrates from 375-900 nm.

FIG. 5 is a graph depicting the optical absorption spectra of ZnP, BD, and ZnP:BD (1:1) adsorbed separately onto transparent TiO₂ substrates from 375-900 nm.

FIG. 6 is a graph depicting the optical absorption spectra of ZnP, BD, and ZnP:BD (1:4) adsorbed separately onto transparent TiO₂ substrates from 375-900 nm.

FIG. 7 is a graph depicting the incident photon-to-current conversion efficiency (IPCE) spectra for DSCs fabricated from ZnP, BD, and ZnP:BD (1:4) sensitized TiO₂ substrates from 300-900 nm.

FIG. 8 is a graph depicting the I-V characteristics for DSCs fabricated from ZnP, BD, and ZnP:BD (1:4) sensitized TiO₂ substrates.

FIG. 9 is a flowchart illustrating a method for fabricating a co-sensitized dye-sensitized solar cell.

### DETAILED DESCRIPTION

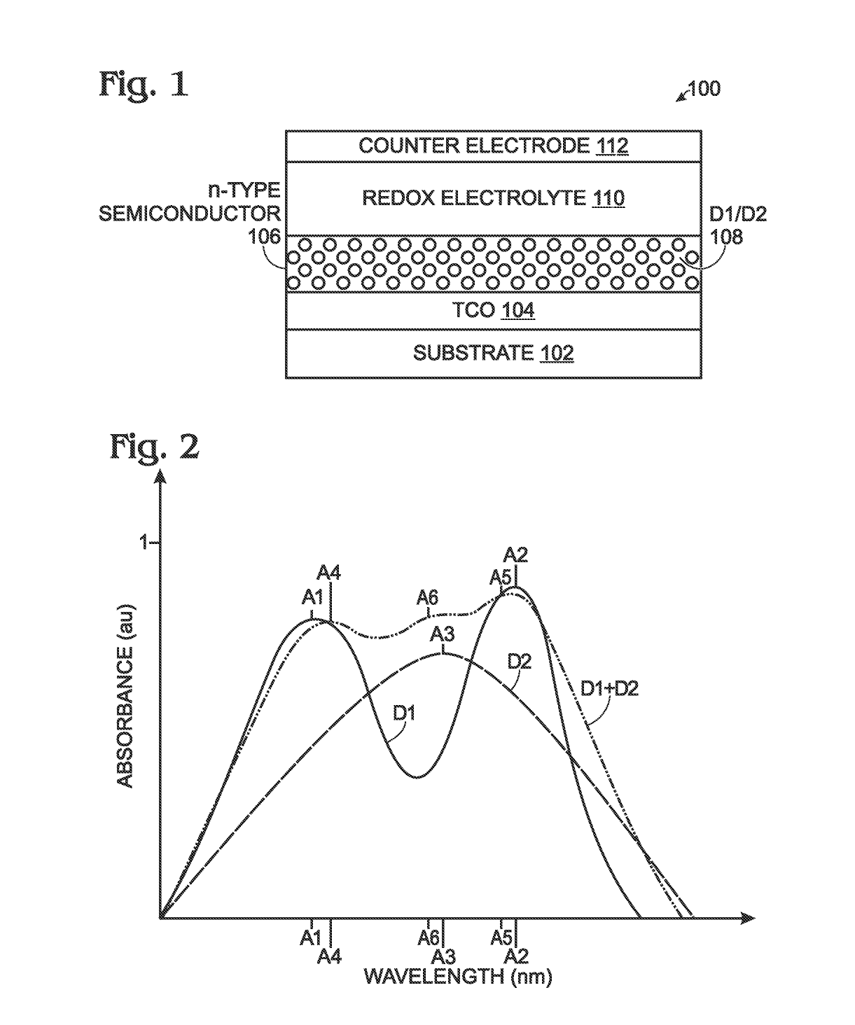

FIG. 1 is a partial cross-sectional view of a co-sensitized dye-sensitized solar cell (DSC). The DSC 100 comprises a transparent substrate 102, such as glass, and a transparent conductive oxide (TCO) film 104 overlying the transparent substrate 102. Some examples of TCO materials include fluorine-doped tin oxide (FTO) and indium tin oxide (ITO). An n-type semiconductor layer 106 overlies the TCO film 104. The n-type semiconductor layer 106 is co-sensitized with a first dye (D1) and a second dye (D2), as represented by reference designator 108. That is, both dyes can independently inject electrons into the n-type semiconductor following illumination. Some examples of n-type semiconductor layer 106 materials include metal oxides of titanium (TiO₂), aluminum (Al₂O₃), tin (SnO₂), magnesium (MgO), tungsten (WOa), niobium (Nb₂O₅), and mixed metal oxides including more than one type of metal. The co-sensitized n-type semiconductor layer 106 may take the form of nanoparticles, nanotubes, nanorods, nanowires, and combinations of the above-mentioned morphologies. Other types of n-type semiconductor materials and forms are known in the art that would be applicable to DSC 100. In one aspect, the first dye (D1) and second dye (D2) are functionalized to the n-type semiconductor layer 106. As is well understood by those with skill in the art, the functionalization of the n-type semiconductor implies the establishment of an intimate association between dyes and the n-type semiconductor surface through chemical bonding, complexation, and/or other means through which electron injection from dye to n-type semiconductor following photo-excitation of the dyes is facilitated.

A redox electrolyte 110 is in contact with the co-sensitized n-type semiconductor layer 106. A counter electrode 112, such as platinum, overlies the redox electrolyte 110. The redox electrolyte 110 may be in the form of a liquid, solid, semi-solid, ionic liquid, or combinations of the above-mentioned forms. Some examples of redox electrolytes include triiodide (I−/I₃−), cobalt (Co²⁺/Co³⁺), ferrocene (Fc/Fc⁺), p-type organic semiconductor molecules and polymers, and perovskite materials.

FIG. 2 is a graph of conceptual absorbance values vs. wavelength, associated with the DSC of FIG. 1. The units of absorbance (au) are normalized with respect to an ideal value of 1. The first dye (D1) has a first optical absorbance local maxima at a first wavelength (A1) and a second optical absorbance local maxima at a second wavelength (A2), longer than the first wavelength. The second dye (D2) has a third optical absorbance local maxima at a third wavelength (A3) between the first wavelength (A1) and the second wavelength (A2). In one aspect as shown, the local maxima at A3 is the point, or range of wavelengths where the absorbance associated for D2 exceeds the absorbance associated with D1.

In one aspect, FIG. 2 is a measurement of the absorbance responses of the individual dyes D1 and D2 as dissolved in solution. In another aspect, the graph is a comparison of a DSC device sensitized with just dye D1, to a DSC device sensitized with just dye D2. As used herein, the term “local maxima” refers to a wavelength associated with relatively high absorbance, but not necessarily the wavelength of maximum absorbance.

For further contrast, the graph depicts the measurement of absorbance of the combination of first dye D1 with second dye D2. Again, the graph may be understood to be a measurement of a solution containing a dye combination of D1 and D2, or a DSC device co-sensitized with D1 and D2. Either way, the combination of the first dye (D1) and second dye (D2) has a fourth optical absorbance local maxima at a fourth wavelength (A4) corresponding to A1. Although A1 and A4 are not perfectly aligned, it is apparent from inspection that the local maxima at A4 is derived from the local maxima at A1, responsive to the first dye D1. Likewise, a fifth optical absorbance local maxima at a fifth wavelength (A5) corresponds to A2, and a sixth optical absorbance local maxima (A6) exists between A4 and A5, greater than the third optical absorbance local maxima (A3). The increase in absorbance in the wavelengths between A4 and A5, as compared to the range of wavelengths between A1 and A2, is responsive to the second dye D2. As shown, A3 and A6 are not perfectly aligned. However, it is apparent from inspection that the local maxima at A6 is derived from the local maxima at A3, responsive to the second dye D2. Although the absorbance at A6 is less than the absorbance at A4 and A5 in this example, it should be understood that in other aspects (not shown), the absorbance at A6 may be greater that at A4 and/or A5.

In one aspect, the first dye (D1) includes a porphyrin material. For example, the porphyrin material may be a metalloporphyrin obtained by complexation with a transition metal. One useful metalloporphyrin is zinc porphyrin (ZnP). In another aspect, the second dye (D2) includes a ruthenium complex. For example, the ruthenium complex may be a ruthenium polypyridyl complex. Specific examples of ruthenium polypyridyl complexes include Black dye (N749 dye), N3 dye, N719 dye, Z907 dye, and C106 dye.

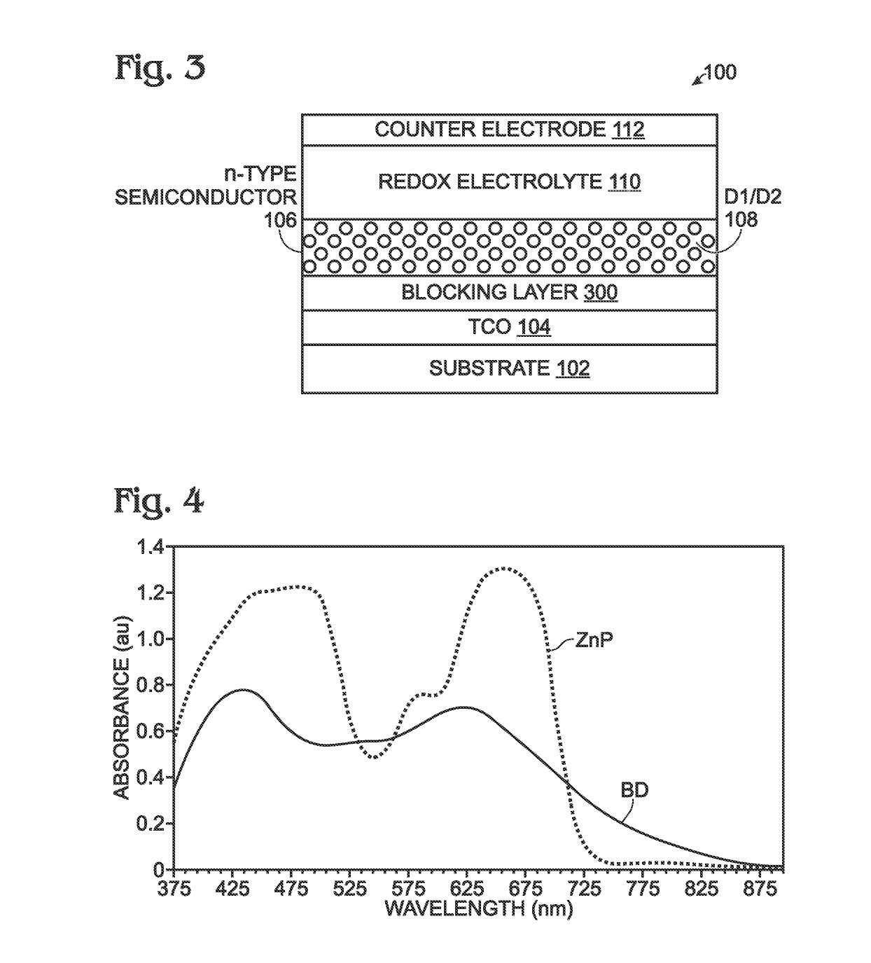

FIG. 3 is a partial cross-sectional view depicting a variation of the DSC of FIG. 1. In this aspect, a blocking layer 300 is interposed between the TCO film 104 and the co-sensitized n-type semiconductor layer 106. In general, the blocking layer comprises a conductive film of metal oxide, such as TiO₂, or mixed metal oxide, which is applied as a thin layer.

In general, porphyrins and metalloporphyrins exhibit strong yet narrow absorbance in the wavelength regions corresponding to the Soret Band, with weaker absorbance for the lower energy Q-Bands. In contrast, ruthenium polypyridyl complexes typically show broad absorption characteristics (˜800 nm for Black dye), yet typically have significantly lower molar absorption coefficients (e) relative to organic sensitizers. Furthermore, it is generally recognized that DSCs fabricated from TiO₂-sensitized substrates using porphyrins, Black dye, and many others benefit from co-adsorption with optically inactive materials to reduce the tendency for these sensitizers to aggregate, both in the dye solution and following adsorption along the TiO₂ surface. In fact, it is widely known that aggregate formation of TiO₂-adsorbed sensitizers leads to a reduction in photovoltaic performance due to unfavorable interactions that favor the effective annihilation of photo-excited states over electron injection to TiO₂. Optionally, co-adsorption of sensitizers with various co-adsorbents may be strategically employed for providing better TiO₂ surface coverage, whereby the optically inactive moieties effectively shield electrons in TiO₂ from the electrolyte to suppress recombination. In contrast to co-adsorption with optically inactive moieties, a zinc porphyrin (ZnP) has been simultaneously co-adsorbed with Black dye (BD), together onto TiO₂ in efforts to avoid aggregate formation and, more importantly at the same time, achieve a synergistic co-sensitization behavior that translates into enhanced photovoltaic performance for DSC.

### Experimental:

TiO₂ Substrates:

In order to correlate the optical absorption data with DSC prototype performance, transparent TiO₂ nanoparticle films on fluorine-doped tin oxide (FTO) were employed.

Dye-Adsorption:

For control DSCs, TiO₂ substrates were immersed (separately) into ethanolic solutions of either zinc porphyrin (ZnP, 0.2 mM) containing deoxycholic acid (DCA, 0.2 mM) or Black dye (BD, 0.2 mM) containing DCA (0.2 mM) for 18 hours at room temperature. For the co-sensitized DSCs, substrates were immersed into an ethanolic solution consisting of a mixture of ZnP (0.1 mM) and BD (0.1 mM or 0.4 mM) with no DCA for 18 hours at room temperature.

Optical Absorption Measurements:

Measurements were performed on sensitized (ZnP:DCA, BD:DCA) and co-sensitized (ZnP:BD) TiO₂ substrates from 375-900 nm.

DSC Fabrication:

A platinum counter-electrode was appended to the dye-sensitized TiO₂ substrates using thermally labile plastic as sealant. Aluminum was evaporated as the counter electrode. DSCs were filled with a triiodide-based electrolyte (I−/I₃− redox system) and subsequently sealed. With the exception of dye-adsorption (18 h), DSC fabrication and all corresponding optical and photovoltaic measurements were performed within the same day.

FIG. 4 is a graph depicting the optical absorption spectra of ZnP and BD adsorbed separately onto transparent TiO₂ substrates from 375-900 nm. ZnP and BD were each co-adsorbed with DCA onto TiO₂ from the same solution in a 1:1 molar ratio [y-axis: Absorbance in arbitrary units (au); x-axis: Wavelength in nanometers (nm)]. For comparison purposes, the optical absorption spectra of TiO₂ films co-adsorbed with (1) ZnP+DCA (1:1 molar ratio) and (2) Black dye (BD)+DCA (1:1 molar ratio) are presented. As used herein, “co-sensitization” is a method for increasing light harvesting ability by functionalizing an n-type semiconductor with 2 (or more) non-identical yet optically-active sensitizer materials. Alternatively stated, “co-sensitization” means that multiple dyes, ZnP and BD in this case, are capable of charge transfer at the n-type semiconductor (TiO₂) surface. In contrast, “co-adsorb” merely refers to the physical process performed for functionalizing an n-type semiconductor through treatment with 2 (or more) non-identical moieties dissolved in solution. The absorption spectra of ZnP and BD-sensitized TiO₂ substrates are typical representatives of the chemical identities for TiO₂ surfaces in DSCs fabricated using either ZnP or BD as primary sensitizer. As mentioned previously, DCA (or similar) is typically added into the dye solution in order to suppress the formation of aggregates and/or shield electrons in TiO₂ from the redox couple. In general, ZnP adsorbed on TiO₂ exhibits strong absorbance in the wavelength regions corresponding to the porphyrin Soret (˜425-525 nm) and Q-Bands (˜575-700 nm) along with only residual absorption beyond ˜725 nm. In contrast, BD shows broad, robust absorption characteristics along the entire visible region and exceeds 800 nm, although the absorbance is lower.

FIG. 5 is a graph depicting the optical absorption spectra of ZnP, BD, and ZnP:BD (1:1) adsorbed separately onto transparent TiO₂ substrates from 375-900 nm. ZnP and BD were each co-adsorbed with DCA onto TiO₂ from the same solution in a 1:1 molar ratio. For ZnP:BD, ZnP and BD were co-adsorbed onto TiO₂ from the same solution in a 1:1 molar ratio without DCA [y-axis: Absorbance in arbitrary units (au); x-axis: Wavelength in nanometers (nm)]. Optical absorption data indicated that despite the fact that ZnP and BD were present in equivalent molar concentrations in the mixed-dye solution, the TiO₂ surface was dominated primarily by characteristic porphyrin absorption features, as shown. For comparison, optical absorption spectra for ZnP and BD-sensitized TiO₂ (control) substrates are presented in the same figure. Not surprisingly, the corresponding DSC prototypes confirmed the optical experiments through domination by porphyrin behaviors as indicated by the IPCE spectra (not shown), although overall DSC performance from the dual sensitizer device was not compromised. Nevertheless, two important conclusions could be drawn from the preliminary observations. First, it is apparent that the rate of adsorption for ZnP is greater than that for BD, at least in the case where the concentration in the mixed dye solution is one to one (ZnP:BD=1:1). More importantly, results from the DSC prototype containing co-adsorbed ZnP and BD suggest that the photovoltaic performance of each dye is not negatively impacted by the presence of the other. This result is fortuitous considering the fact that the energetically favorable deactivation of photo-excited states is not an uncommon occurrence in multi-chromaphore systems. As will be discussed below, strategic co-sensitization with ZnP and BD at appropriate concentrations and ratios affords a favorable, synergistic effect or, quite simply, functions to effectively “reinforce” one another.

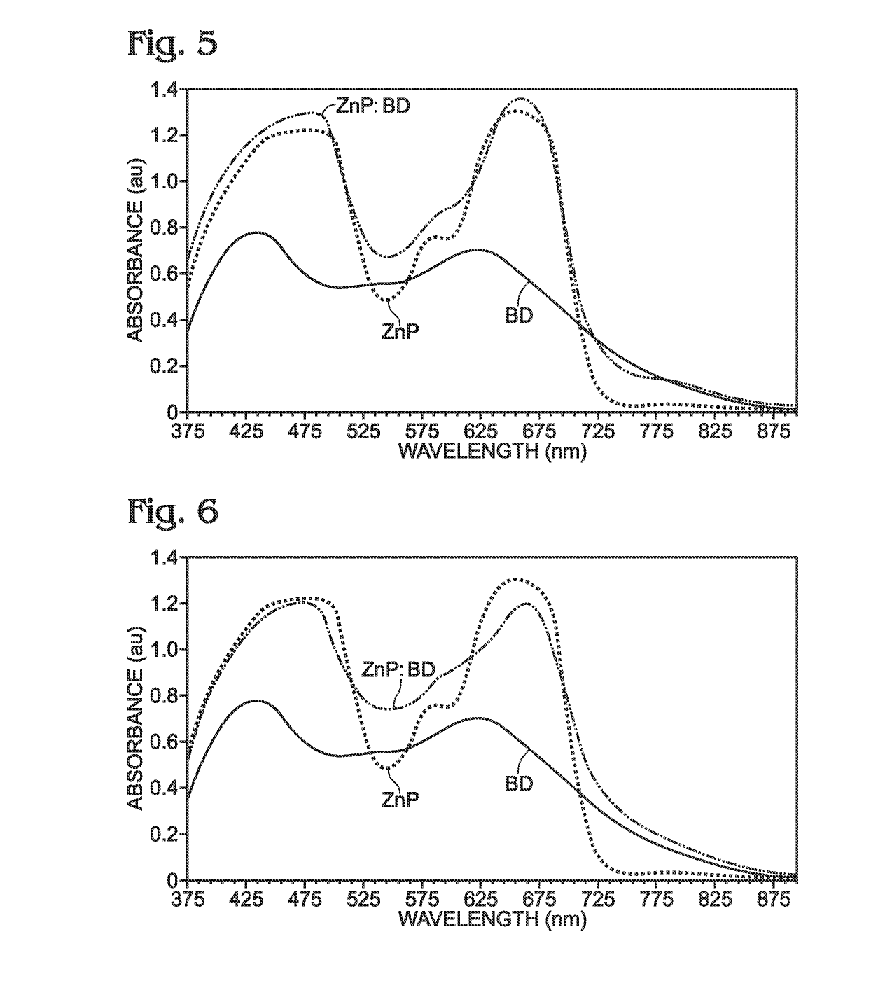

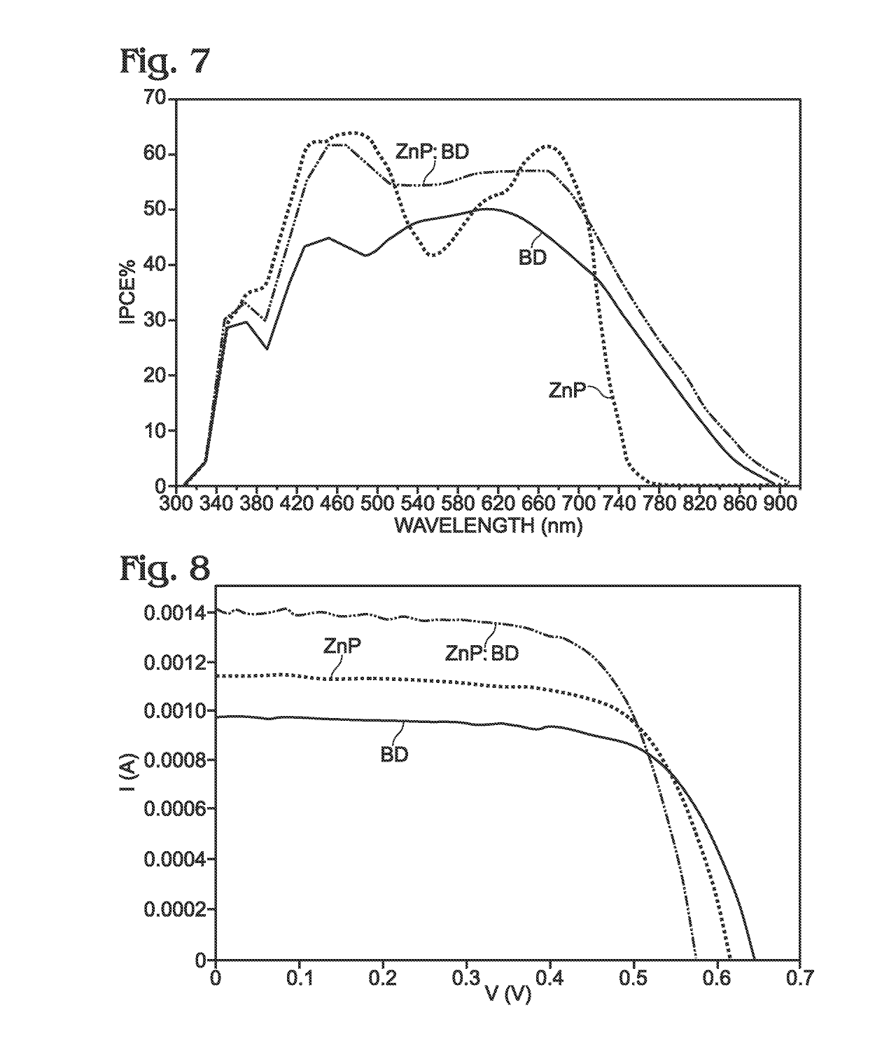

FIG. 6 is a graph depicting the optical absorption spectra of ZnP, BD, and ZnP:BD (1:4) adsorbed separately onto transparent TiO₂ substrates from 375-900 nm. ZnP and BD were each co-adsorbed with DCA onto TiO₂ from the same solution in a 1:1 molar ratio. For ZnP:BD, ZnP and BD were co-adsorbed onto TiO₂ from the same solution in a 1:4 molar ratio without DCA [y-axis: Absorbance in arbitrary units (au); x-axis: Wavelength in nanometers (nm)]. It was rationalized that an increase in Black Dye concentration would compensate for the slower adsorption kinetics for BD relative to ZnP. The optical absorption spectrum for the co-sensitized TiO₂ substrate (ZnP:BD=1:4) is illustrated in the figure. For comparison, optical absorption spectra for ZnP and BD-sensitized TiO₂ (control) substrates are presented in the same figure.

As shown in FIG. 6, the optical absorption spectrum for the co-sensitized ZnP and BD (ZnP:BD=1:4) TiO₂ substrate can be considered to be a hybrid of those from the individually sensitized ZnP and BD substrates. This observation is a clear indication that the absorption spectrum for the co-sensitized TiO₂ substrates represents contributions from significant amounts of both ZnP and BD.

FIG. 7 is a graph depicting the incident photon-to-current conversion efficiency (IPCE) spectra for DSCs fabricated from ZnP, BD, and ZnP:BD (1:4)-sensitized TiO₂ substrates from 300-900 nm. ZnP and BD were each co-adsorbed with DCA onto TiO₂ from the same solution in a 1:1 molar ratio. For ZnP:BD, ZnP and BD were co-adsorbed onto TiO₂ from the same solution in a 1:4 molar ratio without DCA [y-axis: IPCE is percent (%); x-axis: Wavelength in nanometers (nm)]. The figure depicts the IPCE spectra of DSC prototypes for which optical absorption spectra were presented in FIG. 6.

As can be seen from FIG. 7, the photovoltaic performance of DSC prototypes fabricated from TiO₂ substrates co-sensitized with a mixture of ZnP and BD (1:4) is superior to those prepared from either ZnP or BD. Furthermore, the fact that the shape of the IPCE spectrum for the co-sensitized DSCs (ZnP:BD=1:4) is consistent with the optical absorption data (FIG. 6), further confirms a synergistic effect from co-sensitization. Noteworthy is the fact that although ZnP exhibits negligible absorption beyond 750 nm when adsorbed on TiO₂, its co-existence with BD in the co-sensitized TiO₂ film leads to increased red photon absorption which translates into enhanced DSC performance beyond the wavelength range of pristine BD.

FIG. 8 is a graph depicting the I-V characteristics for DSCs fabricated from ZnP, BD, and ZnP:BD (1:4) sensitized TiO₂ substrates. ZnP and BD were each co-adsorbed with DCA onto TiO₂ from the same solution in a 1:1 molar ratio. For ZnP:BD, ZnP and BD were co-adsorbed onto TiO₂ from the same solution in a 1:4 molar ratio without DCA. The I-V curves correspond to the DSCs for which IPCE spectra are presented in FIG. 7 [y-axis: current (I) in amperes (A); x-axis: Voltage in volts (V)].

The I-V characteristics of DSCs fabricated from ZnP, BD and ZnP:BD-sensitized TiO₂ substrates presented in FIG. 8 are also summarized in Table 1. As can be seen from the I-V plots in FIG. 8 and the summary in Table 1, a significant increase in J_{sc} is demonstrated by the co-sensitized (ZnP:BD=1:4) DSC relative to devices fabricated using TiO₂ electrodes sensitized individually by either ZnP or BD, which is rationalized in terms of significant individual contributions to photocurrent from both dyes in the co-sensitized DSC.

TABLE 1

| DSC | | J_{sc} | V_{oc} | | |
|---|---|---|---|---|---|
| Device ID | Sensitizer(s) | (mA/cm²) | (mV) | FF | η (%) |
| A09 | BD:DCA (1:1) | 10.8 | 645 | 68.0 | 4.75 |
| | | [10.9] | [659] | | [4.88] |
| A11 | ZnP:DCA (1:1) | 12.7 | 618 | 68.6 | 5.37 |
| | | [12.7] | [638] | | [5.56] |
| A12 | ZnP:BD (1:4) | 15.6 | 578 | 68.0 | 6.11 |
| | | [15.5] | [628] | | [6.62] |

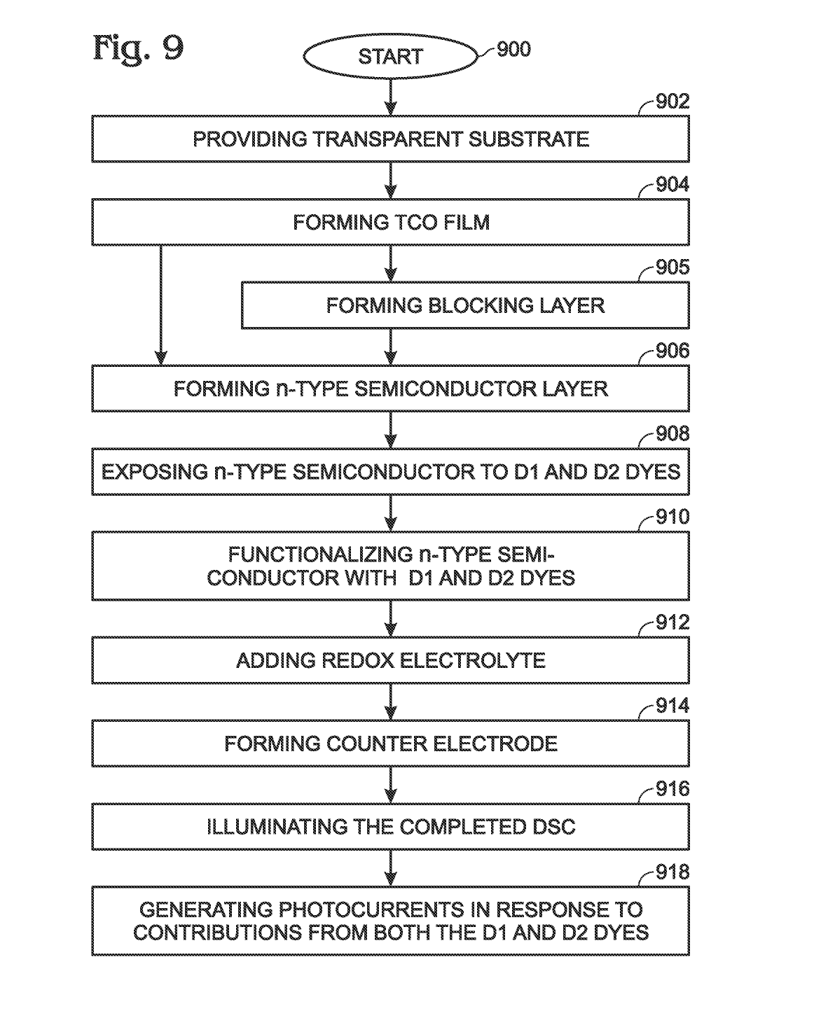

FIG. 9 is a flowchart illustrating a method for fabricating a co-sensitized dye-sensitized solar cell. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 900.

Step 902 provides a transparent substrate. Step 904 forms a transparent conductive oxide (TCO) film overlying the transparent substrate. Step 906 forms an n-type semiconductor layer overlying the TCO. Optionally, in one aspect Step 905 forms a blocking layer interposed between the TCO film and the co-sensitized semiconductor. Step 908-exposes the n-type semiconductor layer to a dissolved first dye (D1) and a dissolved second dye (D2). The first dye (D1) has a first optical absorbance local maxima at a first wavelength (A1) and a second optical absorbance local maxima at a second wavelength (A2), longer than the first wavelength. The second dye (D2) has a third optical absorbance local maxima at a third wavelength (A3) between the first wavelength (A1) and the second wavelength (A2). Step 910 functionalizes the n-type semiconductor layer with the first dye (D1) and the second dye (D2), forming a co-sensitized n-type semiconductor layer. Alternatively stated, D1 and D2 are capable of establishing an intimate contact with the surface of the n-type semiconductor, which may include covalent bonding, complexation, or other modes of interaction. Step 912 adds a redox electrolyte in contact with the co-sensitized n-type semiconductor layer. Step 914 forms a counter electrode overlying the redox electrolyte. Step 916 illuminates the completed DSC. In Step 918 the DSC generates photocurrents, as a result of illumination, in response to contributions from both the D1 and D2 dyes. Alternatively stated, in Step 918 the DSC has optical absorption behaviors that reflect contributions from both the first and second dyes. That is, the DSC has a fourth optical absorbance local maxima at a fourth wavelength (A4) corresponding to A1, a fifth optical absorbance local maxima at a fifth wavelength (A5) corresponding to A2, and a sixth optical absorbance local maxima (A6) between A4 and A5, greater than the third optical absorbance local maxima (A3). Typically, the absorbance at A6 has a correspondence to the absorbance at A3.

In one aspect, exposing the n-type semiconductor layer to the dissolved first dye (D1) and the dissolved second dye (D2) in Step 908 includes simultaneously exposing the n-type semiconductor layer to a mixed solution including dissolved first dye (D1) and dissolved second dye (D2). For example, the mixed solution may contain a molar ratio D1 to D2 (D1:D2) in the range of 1:1 to 1:20 and 1:1 to 5:1. Alternatively, Step 908 sequentially exposes the n-type semiconductor layer with individual solutions of dissolved first dye (D1) and dissolved second dye (D2), where the sequence order is either D1 followed by D2, or D2 followed by D1. In one aspect, the ratio of each dye on the surface can be controlled by the relative amounts of time used to treat the n-type semiconductor with each dye (separately).

A DSC co-sensitized with a combination of dyes has been provided. Examples of particular dyes and DSC components have been provided as examples to illustrate the invention. However, the invention is not limited to merely these examples. Other variations and embodiments of the invention will occur to those skilled in the art.

We claim:

1. A co-sensitized dye-sensitized solar cell (DSC) comprising:
a transparent substrate;
a transparent conductive oxide (TCO) film overlying the transparent substrate;
an n-type semiconductor layer overlying the TCO film, co-sensitized with a first dye (D1) and a second dye (D2);
a redox electrolyte in contact with the co-sensitized n-type semiconductor layer;
a counter electrode overlying the redox electrolyte; and,
wherein the first dye (D1) has a first optical absorbance local maxima at a first wavelength (A1) and a second optical absorbance local maxima at a second wavelength (A2), longer than the first wavelength; and,
wherein the second dye (D2) has a third optical absorbance local maxima at a third wavelength (A3) between the first wavelength (A1) and the second wavelength (A2).

2. The co-sensitized DSC of claim 1 wherein the first dye (D1) includes a porphyrin material.

3. The co-sensitized DSC of claim 2 wherein the porphyrin material is a metalloporphyrin obtained by complexation with a transition metal.

4. The co-sensitized DSC of claim 3 wherein the metalloporphyrin is zinc porphyrin (ZnP).

5. The co-sensitized DSC of claim 1 wherein the second dye (D2) includes a ruthenium complex.

6. The co-sensitized DSC of claim 5 wherein the ruthenium complex is a ruthenium polypyridyl complex.

7. The co-sensitized DSC of claim 1 wherein the first dye (D1) and second dye (D2) are functionalized to the n-type semiconductor layer.

8. The co-sensitized DSC of claim 1 wherein the redox electrolyte is in a form selected from a group consisting of liquid, solid, semi-solid, ionic liquid, and combinations of the above-mentioned forms.

9. The co-sensitized DSC of claim 1 wherein the n-type semiconductor layer is selected from a group consisting of metal oxides of titanium (TiO₂), aluminum (Al₂O₃), tin (SnO₂), magnesium (MgO), tungsten (WOa), niobium (Nb₂O₅), and mixed metal oxides including more than one type of metal.

10. The co-sensitized DSC of claim 1 wherein the n-type semiconductor layer has a form selected from a group consisting of nanoparticles, nanotubes, nanorods, nanowires, and combinations of the above-mentioned morphologies.

11. The co-sensitized DSC of claim 1 further comprising:
a blocking layer interposed between the TCO film and the co-sensitized n-type semiconductor layer.

12. The co-sensitized DSC of claim 1 wherein the combination of the first dye (D1) and second dye (D2) has a fourth optical absorbance local maxima at a fourth wavelength (A4) corresponding to A1, a fifth optical absorbance local maxima at a fifth wavelength (A5) corresponding to A2, and a sixth optical absorbance local maxima (A6) between A4 and A5, greater than the third optical absorbance local maxima (A3).

13. A combination of dyes for co-sensitizing a dye-sensitized solar cell (DSC), the dye combination comprising:
a first dye (D1); and,
a second dye (D2);
wherein the first dye (D1) has a first optical absorbance local maxima at a first wavelength (A1) and a second optical absorbance local maxima at a second wavelength (A2), longer than the first wavelength; and,
wherein the second dye (D2) has a third optical absorbance local maxima at a third wavelength (A3) between the first wavelength (A1) and the second wavelength (A2).

14. The dye combination of claim 13 wherein the first dye (D1) includes a porphyrin material.

15. The dye combination of claim 14 wherein the porphyrin material is a metalloporphyrin obtained by complexation with a transition metal.

16. The dye combination of claim 15 wherein the metalloporphyrin is zinc porphyrin (ZnP).

17. The dye combination of claim 13 wherein the second dye (D2) is a ruthenium complex.

18. The dye combination of claim 17 wherein ruthenium complex is a ruthenium polypyridyl complex.

19. The dye combination of claim 13 wherein the combination of the first dye (D1) and second dye (D2) has a fourth optical absorbance local maxima at a fourth wavelength (A4) corresponding to A1, a fifth optical absorbance local maxima at a fifth wavelength (A5) corresponding to A2, and a sixth optical absorbance local maxima (A6) between A4 and A5, greater than the third optical absorbance local maxima (A3).

20. A method for fabricating a co-sensitized dye-sensitized solar cell (DSC), the method comprising:
providing a transparent substrate;
forming a transparent conductive oxide (TCO) film overlying the transparent substrate;
forming an n-type semiconductor layer overlying the TCO;
exposing the n-type semiconductor layer to a dissolved first dye (D1) and a dissolved second dye (D2), where the first dye (D1) has a first optical absorbance local maxima at a first wavelength (A1) and a second optical absorbance local maxima at a second wavelength (A2), longer than the first wavelength, and where the second dye (D2) has a third optical absorbance local maxima at a third wavelength (A3) between the first wavelength (A1) and the second wavelength (A2);
functionalizing the n-type semiconductor layer with the first dye (D1) and the second dye (D2), forming a co-sensitized n-type semiconductor layer;
adding a redox electrolyte in contact with the co-sensitized n-type semiconductor layer; and,
forming a counter electrode overlying the redox electrolyte.

21. The method of claim 20 wherein exposing the n-type semiconductor layer to the dissolved first dye (D1) and the dissolved second dye (D2) includes simultaneously exposing the n-type semiconductor layer to a mixed solution including dissolved first dye (D1) and dissolved second dye (D2).

22. The method of claim 21 wherein simultaneously exposing the n-type semiconductor layer to the mixed solution includes the solution containing a molar ratio D1 to D2 (D1:D2) in a range of 1:1 to 1:20 and 1:1 to 5:1.

23. The method of claim 20 wherein exposing the n-type semiconductor layer to the dissolved first dye (D1) and the dissolved second dye (D2) includes sequentially exposing the n-type semiconductor layer with individual solutions of dissolved first dye (D1) and dissolved second dye (D2), where the sequence order is selected from a group consisting of D1 followed by D2, and D2 followed by D1.

24. The method of claim 20 further comprising:
illuminating the completed DSC; and,
generating photocurrents in response to contributions from both the first dye (D1) and the second dye (D2).

25. The method of claim 20 further comprising:
forming a blocking layer interposed between the TCO film and the co-sensitized n-type semiconductor layer.
